(19) United States
(12) Patent Application Publication
(10) Pub. No.: US 2026/0206954 A1
(43) Pub. Date: Jul. 23, 2026

(54) A PERSONAL CARE APPARATUS, AN ATTACHMENT, AND A REMOVABLE TOOTHBRUSH HEAD

(71) Applicant: ORKA ONLINE LTD, LONDON (GB)

(72) Inventor: ELLIOT BEECHAM, LONDON (GB)

(21) Appl. No.: 19/143,842

(22) PCT Filed: Dec. 20, 2023
(86) PCT No.: PCT/GB2023/053332

§ 371 Date: Jun. 26, 2025

(30) Foreign Application Priority Data
Jan. 5, 2023 (GB) 2300159.7

(51) Int. Cl. A46B 5/00; A46B 7/04; A46B 13/00; F03G 1/02; F03G 1/08

(52) U.S. Cl. CPC A46B 5/0095; A46B 7/044; A46B 13/00; F03G 1/022; F03G 1/08; A46B 2200/1066

(57) ABSTRACT

There is provided a personal care apparatus, including a housing, a winding mechanism located at a first end of the housing, an escapement mechanism located at a second end of the housing configured to oscillate an attachment, and a plurality of spiral springs connected in series within the housing, the springs connected to the winding mechanism and the escapement mechanism.

### FIELD

This specification relates to personal care apparatuses, attachments for such personal care apparatuses, and removable toothbrush heads. More particularly, but not exclusively, this specification relates to personal care apparatuses, attachments for such personal care apparatuses, and removable toothbrush heads, alone, or in combination.

### BACKGROUND

Personal care apparatuses, such as electrically driven personal care apparatuses, including toothbrushes, are commonly used in hygiene practice. Electric personal care apparatuses require charging using e.g., an adapter connected to an electrical outlet. Further, since electric personal care apparatuses generally include a battery (or batteries), there are environmental concerns in respect of the manufacture and disposal of such electric personal care apparatuses.

Therefore, there is a need to provide an environmentally friendly personal care apparatus.

It is a non-exclusive aim of this specification to alleviate the above-mentioned problems and provide a personal care apparatus that offers equivalent performance to known electric personal care apparatuses, which is simple to construct and are environmentally friendly.

### BRIEF DESCRIPTION OF THE INVENTION

According to a first aspect, there is provided a personal care apparatus, including:
a housing,
a winding mechanism located at a first end of the housing,
an escapement mechanism located at a second end of the housing configured to oscillate
an attachment, and
a plurality of spiral springs connected in series within the housing, the springs connected to the winding mechanism and the escapement mechanism.

The escapement mechanism may be a runaway escapement.

The winding mechanism may comprise a winding shaft extending through the first end of the housing and connected to the plurality of spiral springs.

The winding mechanism may comprise a winding member connected to the winding shaft and configured to impart rotational force on the winding shaft.

The winding member may comprise a winding arm that is pivotably rotatable about the housing to fit into a recess in the housing, such that the winding arm is stowed when not in use.

The plurality of spiral springs may comprise:
a first spiral spring housed within and connected to a first barrel located within the housing adjacent the first end, the first barrel connected to the winding mechanism, and
a terminal spiral spring housed within and connected to a terminal barrel located within the housing adjacent to the second end, the terminal spiral spring connected to the escapement mechanism.

The personal care apparatus may include at least one or more further spiral spring(s) housed in and connected to a respective barrel located within the housing between the first and terminal spiral springs.

The personal care apparatus may further include a planetary gearbox connected to the escapement mechanism and the plurality of spiral springs.

The personal care apparatus may further include a stopping unit for preventing movement of the escapement mechanism.

The personal care apparatus may comprise a fitting connected to the escapement mechanism for receiving the attachment.

The fitting may comprise a female portion for reception of a male portion of the attachment.

The personal care apparatus may comprise a connection member on an inner surface of the female portion of the fitting for engaging with a corresponding portion of the male portion.

The connection member may comprise a ball-plunger and/or a spring clip.

The personal care apparatus may include the fitting for the attachment and the attachment.

The attachment may comprise a male portion for reception by the female portion of the personal care apparatus, the male portion including a side and a corresponding portion for receiving the connection member of the personal care apparatus,

The corresponding portion may be a recess.

The attachment may define a longitudinal axis.

The male portion may have an irregular or polygonal cross-section along the male portion along at least part or all of the longitudinal axis.

The male portion of the attachment may comprise a trapezoidal cross-section and/or a dovetail cross section along at least part of the male portion along at least part of or all of the longitudinal axis at a plane perpendicular to the longitudinal axis.

The side of the male portion may be flat.

The recess may extend across the side from a first edge to a second edge.

The recess may extend around substantially all of the outside of the male portion at a plane perpendicular to the longitudinal axis.

The male portion may comprise four male portion sides corresponding to a trapezoidal cross-section along the male portion along substantially all of the longitudinal axis.

The trapezoidal cross-section may comprise a base side having a first length, two joining sides extending from the base side at an acute angle, and a top side attached to the two joining sides at an obtuse angle.

The top side may have a length less that the base side.

The trapezoidal cross-section may have a cross-section conforming to an isosceles trapezium.

The corresponding portion may comprise a recess for receiving a ball plunger and/or a spring clip. The recess may extend across a plane perpendicular to the longitudinal axis across substantially all of the two sides and the top side.

The recess may extend across a plane perpendicular to the longitudinal axis across substantially all of the two sides and the base side.

The recess may extend across a plane perpendicular to the longitudinal axis across substantially all of the two sides, the base side, and the top side.

At least three of the four sides of the male portion may be configured to abut a corresponding at least three internal sides of the female portion of the fitting, in use, when the male portion is in reception of the female portion of the fitting.

All of the four sides of the male portion may be configured to abut a corresponding at least three internal sides of the female portion of the fitting, in use, when the male portion is in reception of the female portion of the fitting.

The attachment may be a removable toothbrush head.

The toothbrush head may comprise a toothbrush arm extending along the longitudinal axis.

The toothbrush head may be attached to the male portion and may comprise a bristle portion.

The personal care apparatus may be a toothbrush.

The attachment may be a removable toothbrush head.

According to a second aspect there is provided an attachment for a personal care apparatus as described herein, wherein the attachment comprises a male portion for reception by a female portion of a fitting of the personal care apparatus, the male portion including a side having a corresponding portion for receiving a connection member of the personal care apparatus, wherein the attachment defines a longitudinal axis, wherein the corresponding portion is a recess, and, wherein the male portion has an irregular or polygonal cross-section along the male portion along at least part or all of the longitudinal axis.

The male portion may have an irregular or polygonal cross-section.

The attachment may define a longitudinal axis.

The male portion may have an irregular or polygonal cross-section along the male portion along at least part or all of the longitudinal axis.

The male portion may have a cross-sectional order of symmetry of 1.

The male portion of the attachment may comprise a trapezoidal cross-section and/or a dovetail cross section along at least part of the male portion along at least part of or all of the longitudinal axis at a plane perpendicular to the longitudinal axis.

The side of the male portion may be flat.

The recess may extend across the side from a first edge to a second edge.

The recess may extend around substantially all of the way around the outside of the male portion at a plane perpendicular to the longitudinal axis.

The recess may extend around at least two-thirds of the way around the outside of the male portion at a plane perpendicular to the longitudinal axis.

The male portion may comprise four male portion sides corresponding to a trapezoidal cross-section along the male portion along substantially all of the longitudinal axis.

The trapezoidal cross-section may comprise a base side having a first length, two joining sides extending from the base side at an acute angle, and a top side attached to the two joining sides at an obtuse angle.

The top side may have a length less that the base side.

The trapezoidal cross-section may have a cross-section conforming to an isosceles trapezium.

The corresponding portion may comprise a recess for receiving a ball plunger and/or a spring clip. The recess may extend across a plane perpendicular to the longitudinal axis across substantially all of the two sides and the top side.

The recess may extend across a plane perpendicular to the longitudinal axis across substantially all of the two sides and the base side.

The recess may extend across a plane perpendicular to the longitudinal axis across substantially all of the two sides, the base side, and the top side.

At least three of the four sides of the male portion may be configured to abut a corresponding at least three internal sides of the female portion of the fitting, in use, when the male portion is in reception of the female portion of the fitting.

All of the four sides of the male portion may be configured to abut a corresponding at least three internal sides of the female portion of the fitting, in use, when the male portion is in reception of the female portion of the fitting.

The attachment may be a removable toothbrush head.

The toothbrush head may comprise a toothbrush arm extending along the longitudinal axis.

The toothbrush head may be attached to the male portion and may comprise a bristle portion.

The attachment may include a personal care apparatus and the fitting.

The fitting may comprise a connection member on an inner surface of the female portion for engaging with a corresponding portion of the male portion.

The connection member may comprise a ball-plunger and/or a spring clip.

The attachment may be a removable toothbrush head.

The personal care apparatus may be a toothbrush.

According to a third aspect there is provided a removable toothbrush head. The removable toothbrush head may have any of the features of the attachment as described herein.

The toothbrush head may have a fixed bristle portion.

The removable toothbrush head may include a removable bristle portion comprising a side having a recess for receiving a head connection member.

The side of the removable toothbrush head may be flat. The side of the removable toothbrush head may have a semi-circular cross-section.

The removable toothbrush head may include a toothbrush head arm comprising the head connection member.

The removable bristle portion may be slidable along the arm along the longitudinal axis into a receiving portion of the toothbrush head arm.

The head connection member may engage with the recess of the removable bristle portion such that the removable bristle portion may be retained on the toothbrush head arm.

The head connection member of the toothbrush head arm may comprise a ball-plunger and/or a spring clip.

The head connection member of the toothbrush head arm may comprise a spring clip.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a side cutaway view of a personal care apparatus and an attachment according to an embodiment;

FIG. 2 is an isometric view of an attachment connected to an escapement mechanism, according to an embodiment;

FIG. 3 is an exploded isometric view of the escapement mechanism of FIG. 2;

FIG. 4 is a partially exploded isometric view of a plurality of spiral springs according to an embodiment;

FIG. 5 is an exploded isometric view of an attachment, a fitting, and part of a personal care apparatus according to an embodiment;

FIG. 6 is an exploded isometric view of a removable toothbrush head according to an embodiment;

FIG. 7 is a top-down view of a toothbrush head according to an embodiment, showing the direction of oscillation of the toothbrush head; and

FIG. 8 is an isometric view of attachments having male portion cross-sectional shapes of varying shapes.

### DETAILED DESCRIPTION OF THE DISCLOSURE

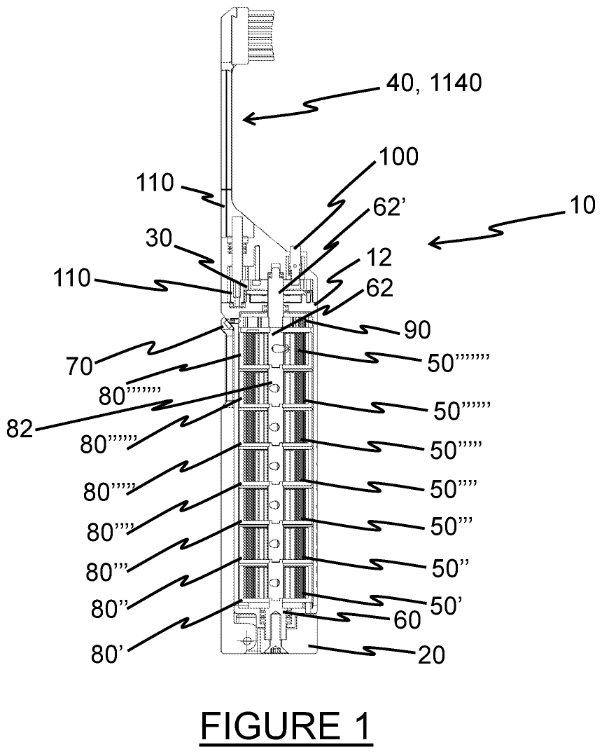

With reference to FIG. 1, according to a first aspect of the disclosure, there is provided a personal care apparatus 10. The personal care apparatus 10 includes a housing 12, a winding mechanism 20 located at a first end of the housing 12, an escapement mechanism 30 located at a second end of the housing 12 configured to oscillate an attachment 40, and a plurality of spiral springs 50 connected in series within the housing 12, the springs connected to the winding mechanism 20 and the escapement mechanism 30.

Spring driven personal care apparatuses generally have a limited run time due to the runtime limitations offered by the springs used, and often require complex gear-mechanisms to translate force output by such springs to rotational and/or oscillatory motion. A personal care apparatus 10 as described above may allow for a run-time of the personal care apparatus 10 at least equivalent to that of similar electronically (i.e., battery) powered personal care apparatuses. Run-time in the context of the personal care apparatus 10 is taken to be the amount of time that the spiral springs 50 provide rotational force to the escapement mechanism 30 in use. Further, the personal care apparatus 10 does not require a power source for use, as required by battery powered personal care apparatuses that inevitably run out of power; the personal care apparatus 10 of the present disclosure may be used repeatedly, in the absence of electrical power.

The escapement mechanism 30 may be a runaway escapement. The escapement mechanism 30 may comprise an escapement wheel 32 and an escapement rocker 34 in surface contact with the escapement wheel 32, such that rotation of the wheel causes oscillation of the rocker. Oscillation of the rocker in this case is therefore about a longitudinal axis A of the attachment 40, 1140, as shown in relation to a toothbrush head attachment 40, 1140 as shown in FIG. 7 and described in more detail below.

Escapement mechanisms 30 as described above are advantageous. In particular, when the spiral springs 50 are wound up and then released, the escapement wheel 32 is enabled to rotate. The escapement mechanism 30 as described above allows for multiple (e.g., 3 to 10) oscillations of an attachment 40 per one complete rotation of the escapement wheel 32. An oscillation motion is illustrated in FIG. 7 illustrating the attachment 40 as a toothbrush head; as can be seen by the double headed arrow, a complete oscillation is rotational movement of the attachment 40 from the central dashed line 220, to the left 230 (or right 240) dashed line, to the opposite (i.e., right or left respectively) dashed line, and back to the central dashed line. The escapement mechanism 30 may therefore allow for a full oscillation of a toothbrush head, or other attachment 40, in use (i.e., when looked at from above, a rotation to approximately 45 degrees to the right, to approximately 45 degrees to the left, to a resting position looking straight-on), for a fraction (e.g., 1/16th) of a turn of the escapement wheel 32. In other words, the toothbrush head, or other attachment 40, may oscillate multiple times for one full turn of the escapement wheel 32.

Accordingly, when a plurality of spiral springs 50 are connected in series, there may be a large number of effective spring rotations, allowing for a run-time of the personal care apparatus 10 appropriate for the use (e.g., if the personal care apparatus 10 is a toothbrush, then the run-time may be sufficiently long enough for a user to brush their teeth). The escapement mechanism 30 of the present invention may be further advantageous—the use of the escapement mechanism 30 is opposite to that of known escapement mechanism 30 usage, in that the escapement mechanism 30 of the present disclosure is used to impart a large number of fast oscillations to the attachment 40 per spring 50 unwinding, rather than providing a limited number of oscillations per spring 50 unwinding.

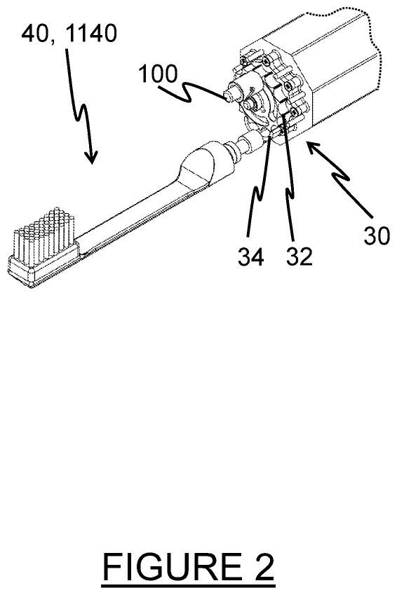

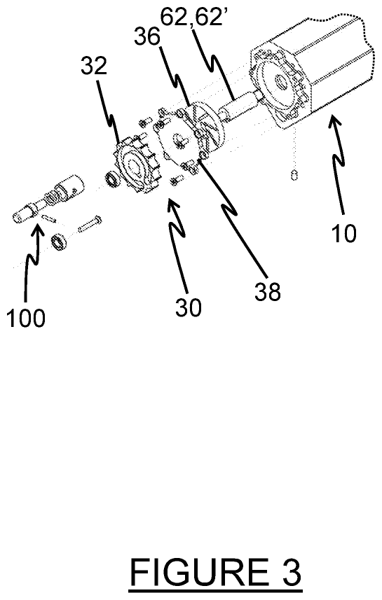

The runaway escapement mechanism 30 is described in more detail as follows. The escapement mechanism 30 may comprise an escapement wheel 32 and an escapement rocker 34 in surface contact with the escapement wheel 32. The escapement mechanism 30 may be directly or indirectly connected to the spiral springs 50 within the housing 12. An example of a direct connection is the escapement wheel 32 being connected to a drive shaft 62, which extends through the second end of the housing 12, the drive shaft 62 in connection with the plurality of spiral springs 50. An example of an indirect connection is the escapement wheel 32 being connected to a planetary gearbox 90, which is then connected to the plurality of spiral springs 50, as described in more detail below. The escapement wheel 32 may include an undulating and/or uneven periphery surface, as shown in FIGS. 2 and 3. The undulating and/or uneven surface provides a surface in which the escapement rocker 34 may oscillate back and forth when the escapement wheel 32 rotates. The periphery surface of the escapement wheel 32 may comprise teeth.

The winding mechanism 20 may comprise a winding shaft 60 extending through the first end of the housing 12 and connected to the plurality of spiral springs 50.

The winding mechanism 20 may comprise a winding member connected to the winding shaft 60 and configured to impart rotational force on the winding shaft 60.

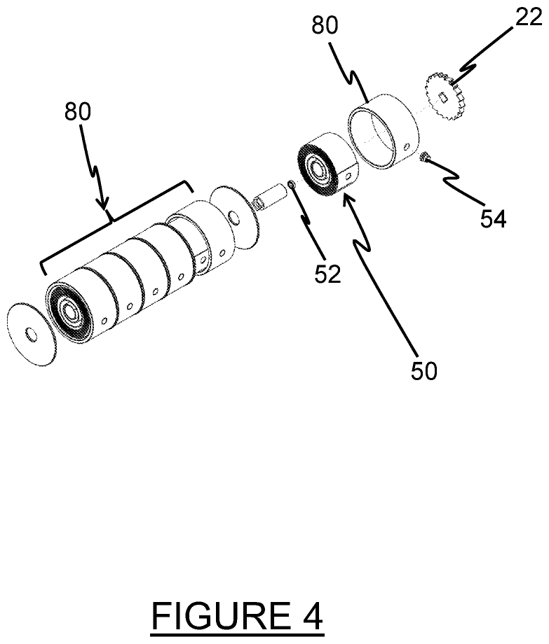

There may be a ratchet and pawl mechanism (comprising a ratchet wheel 22 indicated generally in FIG. 4, pawl not shown) connected to the winding shaft 60. The rachet and pawl mechanism may include multiple pawls, e.g., two pawls, or three pawls, or four pawls, distributed around the ratchet. Such a configuration of multiple pawls may provide increased stopping power against the ratchet and/or may provide increased resistance against, e.g., slippage of the ratchet. There may also be multiple ratchet and pawl mechanisms connected in series. The ratchet and pawl mechanism may therefore allow for the plurality of spiral springs 50 to be wound up, and once the winding has stopped, the springs 50 may be prevented from unwinding (at the winding end).

The winding member may comprise a winding arm 70 that is pivotably rotatable about the housing 12 to fit into a recess in the housing 12, such that the winding arm 70 is stowed when not in use. The pivotable rotation of the winding arm 70 may be perpendicular to a plane defined by rotation of the winding arm when used to wind up the spiral springs 50. The winding arm 70 may be connected to the winding shaft 60, when present. As shown in FIG. 1, the winding arm 70, when stowed, may therefore be flush with the housing 12, allowing for a user to effectively grip the housing 12, and which may allow for prevention of the winding arm 70 hanging loose and creating a distraction to the user, in use.

The plurality of spiral springs 50 may comprise a first spiral spring 50′ housed within and connected to a first barrel 80′located within the housing 12 adjacent the first end, the first barrel 80′ may be connected to the winding mechanism 20, and a terminal spiral spring 50′″″″ may be housed within and connected to a terminal barrel 80′″″″ located within the housing 12 adjacent to the second end, the terminal spiral spring 50′″″″ connected to the escapement mechanism 30. The first barrel 80′ may be connected to a winding shaft 60. The winding shaft 60 may extend through the first end of the housing 12. The winding shaft 60 may be connected to the winding mechanism 20, e.g., the winding arm 70. The terminal spiral spring 50′″″″ may be attached to the drive shaft 62. The terminal barrel 80′″″″ may have a terminal barrel shaft 82 as shown in FIG. 1. As shown in FIG. 1, the terminal barrel shaft 82 is connected to the centre of a spiral spring 50′″″″ located below the terminal barrel 80′″″″. In examples (not shown), the terminal barrel shaft may be connected to the first spiral spring.

With reference to FIG. 1, the personal care apparatus 10 may include at least one or more further spiral spring(s) 50″, 50′″, 50″″, 50′″″, 50′″″″ housed in and connected to a respective barrel located within the housing 12 between the first and terminal spiral springs 50′, 50′″″″.

As will be understood by the skilled person, increasing the number of spiral springs 50 in the housing 12 may significantly increase the run-time of the personal care apparatus 10, i.e., a large number of spiral springs 50 connected in series e.g., seven springs 50, may allow for an effective run-time of greater than if e.g., two springs 50 are used. Each respective barrel 80 may have its own respective shaft for connecting to the centre of a spiral spring located adjacent (i.e., below as shown in FIG. 1). Each respective shaft may be fixedly connected to each respective barrel 80. Each spring 50 may be fixed to its respective barrel 80 at an outer terminal end of each spring 50 (as shown in FIG. 4). Each spring 50 may be fixed to its respective barrel 80 at an outer terminal end of each spring by an engagement pin.

It will be appreciated by the skilled person that the springs 50 may be connected in series without being housed in barrels 80.

When the springs 50 are housed in barrels 80 and the barrels include respective shafts extending below the barrel (i.e., with reference to FIG. 1, barrel 80′″″″ is connected to terminal barrel shaft 82 below), when the winding mechanism 20 is wound, the winding shaft 60 will rotate, rotating the first barrel 80′ and therefore the first spiral spring 50′. The rotation of the barrel above (either the terminal barrel shaft or a subsequent respective barrel, e.g., a second barrel 80″ and second shaft, located within first barrel 50′ as shown in FIG. 1) will be resisted by the spring resistance of the spring(s) located above, until a torque is overcome, at which point, the second barrel 80″ and second shaft will begin to rotate (in addition to the first barrel). This mechanism continues until all spiral springs 50 in the housing 12 are tightened. It will be appreciated that the drive shaft 62, if present, may be prevented from rotating in order to provide a resistance at the second end of the housing 12 and to prevent the escapement mechanism 30 from rotating until desired. A bearing 52 may be placed between each shaft as shown in FIG. 4; such a bearing may provide increased slip between each shaft, increasing the ability of each shaft to rotate independently of one-another, and reducing resistance when the spiral springs 50 unwind. The escapement mechanism 30 may further comprise a regulator disc 36 and a regulator cover 38 as shown in FIG. 3. The regulator disc 36 and regulator cover 38 may be positioned between the escapement wheel 32 and the springs 50, and may be connected to the drive shaft 62, such that the regulator disc 36 and regulator cover 38 may be in frictional engagement, which may provide a frictional force to the regulator disc 36 and regulate rotation 38 of the escapement wheel 32.

The personal care apparatus 10 may further include a planetary gearbox 90 connected to the escapement mechanism 30 and the plurality of spiral springs 50.

The planetary gearbox 90 may be located between the escapement mechanism 30 and the plurality of spiral springs 50. In particular, the terminal spiral spring 50′″″″ may be connected to the drive shaft 62, which may act as an input shaft to the planetary gearbox 90, i.e., the input shaft of the planetary gearbox 90 may be equivalent to the drive shaft 62 as described above. The planetary gearbox 90 may then have an output shaft 62′, connected to the escapement mechanism 30 (e.g., the escapement wheel 32), acting as a drive shaft for the escapement mechanism (i.e., performing the function of drive shaft 62 such as when no planetary gearbox 90 is present).

The planetary gearbox 90, when present in the personal care apparatus 10, provides advantages. In particular, the unwinding of the spiral springs 50 may be converted into multiple complete rotations of the escapement wheel 32. When the planetary gearbox 90 is connected to the drive shaft 62 as described above, one complete rotation of the drive shaft 62 may result in a plurality of complete rotations of the output shaft 62′, e.g., one complete rotation of the drive shaft 62 may be converted into three, four, five, six, or seven, or eight, or nine, or ten complete rotations of the planetary gearbox 90 output shaft 62′. Therefore, the planetary gearbox 90 may convert the torque output by the unwinding of the plurality of spiral springs 50 into a multiple, lower torque, rotations at the output of the planetary gearbox 90. In other words, high-torque, low revolution per minute (RPM), rotations may be converted into lower-torque, higher-RPM, rotations. Such higher-RPM, lower torque, rotations are advantageous in use, as, if the attachment 40 is a toothbrush head, for example, too high of a torque provided to the escapement mechanism 30 may provide discomfort to the user by oscillating the attachment 40 with too much force. Further, reducing the torque may allow for the attachment 40, in this example being a toothbrush head, to be stopped if the user presses too hard against their teeth, preventing oral damage. Furthermore, the run-time of the personal care apparatus 10 may be extended using the planetary gearbox 90, as the unwinding of the springs 50 may be resisted by the planetary gearbox 90, such that the springs 50 may unwind at a slower rate than if a planetary gearbox 90 were not present. Further, the rotation increasing effect as described above, when used with an escapement wheel 32 having multiple undulations, may be significantly increased, resulting in multiple oscillations of the attachment 40 per one rotation of the drive shaft 62 (i.e., resultant from the spiral springs 50 unwinding), e.g., 20, 30, or 40 oscillations per one complete rotation of the drive shaft 62.

The use of a planetary gearbox 90 of the present application therefore provides unusual advantages, previously planetary gearboxes have been used in the opposite way, i.e., to impart multiple rotations of an input into fewer, higher torque, rotations, for example when a user would otherwise be unable to use a small-diameter twisting handle to wind spiral springs, since the torque required to act against the force of the springs would not otherwise be achievable by direct rotation, and therefore greater torque is required, provided by a planetary gearbox.

As shown in FIG. 2, the personal care apparatus 10 may further include a stopping unit 100 for preventing movement of the escapement mechanism 30. Use of a stopping unit 100 provides advantages. In particular, in use, when the user is winding the spiral springs 50, the rotation of the escapement mechanism 30 may be prevented, ultimately providing resistance against the winding of the spiral springs 50, reducing the time to wind-up the spiral springs 50. Further, in use, a user may not require use of the complete run-time of the personal care apparatus 10, and therefore may stop the oscillation of the attachment 40 at any time, when the use is complete. The stopping unit 100 may be a button (as shown in FIGS. 1 to 3), or a lever, or a ratchet and pawl mechanism.

The personal care apparatus 10 may comprise a fitting 110, 1100 connected to the escapement mechanism 30 for receiving the attachment 40. The fitting 110, 1100 may therefore be connected to the escapement rocker 34 and therefore translate the oscillating motion from the escapement rocker 34 to the attachment 40, when attached.

The fitting 110, 1100 may comprise a female portion 120 for reception of a male portion 130, 1130 of the attachment 40. The fitting 110, 1100 may therefore readily receive an attachment 40 having a corresponding male portion 130, 1130. The fitting 110, 1100 may therefore secure the attachment 40 to the personal care device. Further, the fitting 110, 1100 may therefore comprise a female portion 120 shaped and sized to receive the male portion 130, 1130 of the attachment 40 securely, described in more detail below.

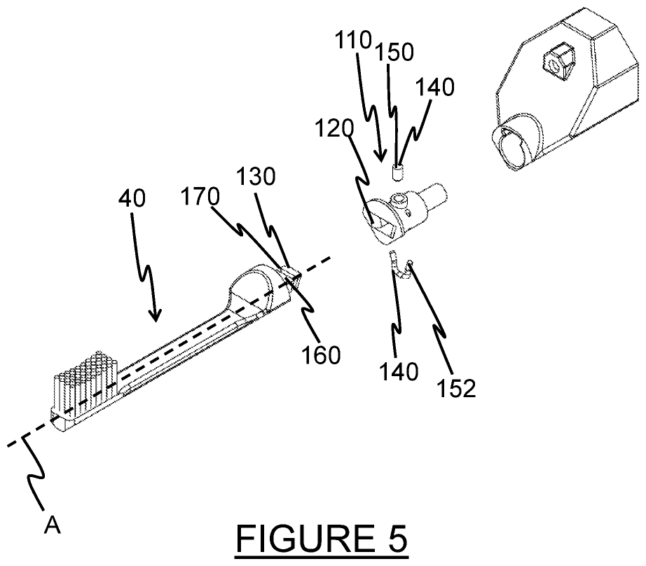

The personal care apparatus 10 may comprise a connection member 140 on the fitting 110 for engaging with a corresponding portion of the male portion 130. The personal care apparatus 10 may comprise a connection member 140 on an inner surface of the female portion 120 of the fitting 110 for engaging with a corresponding portion of the male portion 130. The connection member 140 may comprise a ball-plunger 150. As shown in FIG. 5, the connector may additionally or alternatively comprise a spring clip 152. The connection member 140 as described may therefore readily secure the attachment 40 to the fitting 110, and provide resistance against removal of the attachment 40 from the fitting 110. Further, the connection member 140 as described may provide tactile feedback (e.g., a click feeling and/or noise) to notify the user that the attachment 40 is secured in the fitting 110. Further, as shown in FIG. 5, the connection member 140, such as a spring clip 152, need not be on an inner surface of the female portion 120 and, in the case of the spring clip 152, may be provided around an outer portion of the fitting 110 to secure the male portion 130 of the attachment 40 within the fitting 110. The spring clip 152 may be positioned externally to the attachment 40 and fit into a recess external, and/or extending through the attachment 40 to secure the attachment 40 to the personal care apparatus. The male portion 130 and female portion 120 may be configured such that the spring clip 152 may extend through the female portion 120 to secure the male portion 130 within the female portion 120. When configured in this way, the male portion 130 of the attachment 40 may have a recess 170 on a side (which may be flat, as shown in FIG. 5) as described above, or may have a recess on another side (e.g., if the flat side is present, then the recess may be on an e.g., opposite side, which may not be flat).

The personal care apparatus 10 may include the fitting 110, 1100 for the attachment 40 and the attachment 40. Accordingly, the personal care apparatus 10, the fitting 110, 1100, and the attachment 40 may be conveniently provided as a kit, or may pre-constructed for immediate use.

The attachment 40 may comprise a male portion 130 for reception by the female portion 120 of the personal care apparatus 10. The male portion 130 may include a side 160 having a corresponding portion for receiving the connection member 140 of the personal care apparatus 10. The side 160 may be flat. The corresponding portion may be a recess 170. Attachments 40 having a flat side 160 provide advantages, in that, in contrast to e.g., a fully cylindrical male portion 130, the flat side 160 may secure against a corresponding flat side of the fitting 110 and prevent rotational movement of the attachment within the fitting 110, allowing the oscillatory movement provided by the escapement mechanism 30 to be efficiently translated to the attachment. The recess 170 may allow for secure fitting 110 of the male portion 130 of the attachment within the fitting 110, as described above. Further corresponding shapes between the female portion 120 and the male portion 130 may provide equivalent advantages as the flat male portion 130 as described above; for example, a male portion having a semi-circular, or trapezoidal, or dovetail cross section and a female portion having a corresponding shaped cross-section may prevent rotational movement of the attachment 40 within the fitting 110 as described herein.

The attachment 40 may define a longitudinal axis. In particular, the attachment 40 may have a length which defines the longitudinal axis, as shown by A in FIG. 5. The attachment may therefore have an elongate body attached to the male portion 130. The elongate body may have a trapezoidal cross-section along at least part of the longitudinal axis A extending along the elongate body. The male portion may have an irregular or polygonal cross-section along the male portion along at least part or all of the longitudinal axis A.

The male portion 130 of the attachment 40 may comprise a trapezoidal cross-section and/or a dovetail cross-section along at least part of the longitudinal axis A. As shown in FIG. 5, the male portion 130 may have a trapezoidal cross-section and/or a dovetail cross section along at least part of, or all of, the male portion extending along the longitudinal axis A at a plane perpendicular to the axis. In other words, the male portion 130 may have a trapezoidal cross-section and/or a dovetail cross section along at least part of the longitudinal axis A along a length of the male portion extending along the longitudinal axis A. Therefore, the shape of the male portion may correspond to a trapezoidal prism and/or a dovetail prism along at least the length of the male portion. It will be appreciated that the shape of the male portion 130 may not be uniform along all of the length of the male portion 130 (i.e., where the recess is present, which may itself correspond to a trapezoid and/or dovetail (or another shape as described herein) cross-section of smaller cross-sectional area than the rest of the male portion 130). The trapezoidal cross-section may comprise an isosceles trapezium, a scalene trapezium, and/or a trapezium comprising a right angle between two of the sides of the trapezium. Male portions 130 having a trapezoidal cross-section and/or a dovetail cross section along at least part of, or all of, the longitudinal axis A at a plane perpendicular to the axis may provide advantages. In particular, that rotational movement of the male portion 130 when connected to the female portion 120 may be substantially prevented by virtue of the shape of the male portion 130 and the corresponding female portion 120. Further, such shapes (trapezoidal and/or dovetail) may allow for ease of manufacturing using eco-friendly materials such as bamboo. Furthermore, male portions having a cross-section that is not rotationally symmetrical (e.g., a trapezium and/or dovetail) may only enable the attachment/engagement of the male portion to 130 to/with the female portion 120 in a specific (single) orientation. The male portion 130 may have a rotational symmetry of order 1. The rotational symmetry of order 1 may be about the longitudinal axis A.

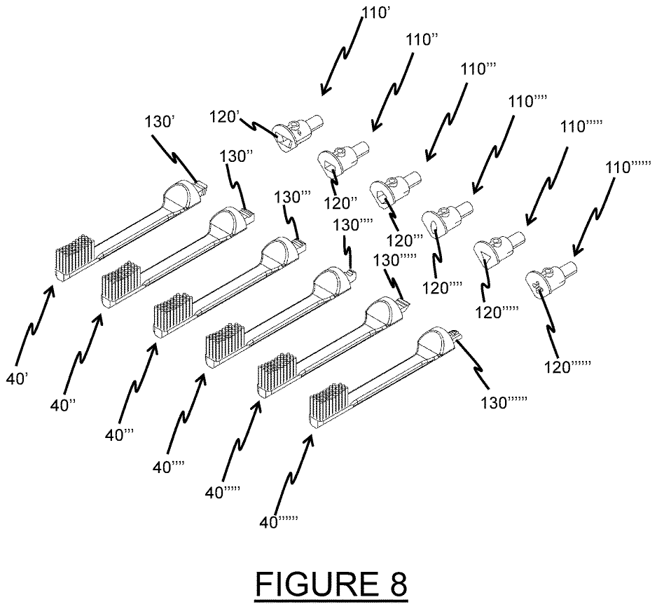

Further, with reference to FIG. 8, it will be appreciated by the skilled person that alternative-shaped cross-sections may be used. FIG. 8 shows examples of the attachment 40 (represented as 40′, 40″, 40′″, 40″″, 40′″″, 40′″″″) having various shaped male portions 130 (represented as 130′, 130″, 130′″, 130″″, 130′″″, 130′″″″) with fittings 110 (represented by represented as 110′, 110″, 110′″, 110″″, 110′″″, 110′″″″) having corresponding female portion 120 shapes (represented as 120′, 120″, 120′″, 120″″, 120′″″, 120′″″″) e.g., triangular, irregular trapezoidal (i.e., a trapezium without symmetry), semi-circular, square, crescent moon shaped, etc. With reference to FIG. 8, the male portion 130 of the attachment 40 may comprise an irregular, a circular, oval (represented by 130′″″ in FIG. 8), triangular (represented by 130′″″ in FIG. 8), quadrilateral (e.g., rectangular as represented by 130″ in FIG. 8 or trapezoidal as represented by 130′ in FIG. 8)), pentagonal, hexagonal (represented by 130′″ in FIG. 8), heptagonal, and/or octagonal cross section, and/or any polygonal shaped cross-section, e.g., a cross-shaped cross-section (represented by 130′″″″ in FIG. 8), along at least part of (or all of) the length of the male portion. Further, the fitting 110 may therefore comprise a female portion 120 shaped and sized to receive the male portion 130 of the attachment 40 securely, e.g., shaped to correspond to the cross-sectional shape of the male portion 130, such that free movement of the male portion 130 when engaged within the female portion 120 of the fitting 110 is minimised. For example, as represented in FIG. 8, the female portion 120 may have a cross section that is: trapezoidal 120′, rectangular 120″, hexagonal 120′″, oval 120′″″, triangular 120′″″, or cross-shaped 120′″″″. Further, the male portion may transition from a cross-section of a first shape (any of the shapes as described above) to a cross-section of a second shape (any of the other shapes as described above). At least one of the corners of the shape of the male portion 130 (i.e., where two sides or faces join at an edge) may be chamfered, rounded, and/or radiused. A male portion 130 having n number of faces (i.e., sides) may abut n or n−1 number of faces against a corresponding number of internal faces of the female portion 120, such that rotational movement of the male portion 130 when connected to the female portion 120 may be substantially prevented, increasing the friction fit of the male portion 130 and the female portion 120. The attachment 40 may be slidably connectable to the fitting 110 along the longitudinal axis A.

As shown in FIG. 5, the recess 170 may extend across the side 160 (which may be flat, as shown in FIG. 5) from a first edge to a second edge. When the recess 170 is provided in this way, the recess 170 may receive the connection member 140 readily. The recess 170 may extend around all of, all but one, or all but two, or all but three sides of the male portion, in particular, if the male portion has n number of sides (e.g., a male portion with a square or trapezoidal cross-section has four), then the recess may extend around n, n−1, n−2, n−3 . . . n−(n−3), n−(n−2), n−(n−1) sides of the male portion 130 (i.e., the recess may extend around any number of sides up to and including n sides). The recess 170 may extend around substantially all of the male portion 130. Recesses 170 when configured as described above may further allow the male portion 130 to engage with the fitting 110, if, e.g., a spring clip 152 and a ball-plunger 150 were used, or if two ball plungers were used to secure the attachment 40 to the fitting 110, and may allow for flexibility in the positioning of said spring clips and/or ball plunger(s). The spring clip 152 may fit in to the same recess as the ball plunger. The fitting may be removably or permanently fixed to the personal care device 10.

By way of example, a preferred embodiment of the attachment 40 is described with reference to FIG. 5. It will be appreciated by the skilled person that the preferred features of the attachment 40 as described below may be included with any of the features of the attachment 40 as described herein. The attachment 40 may comprise a male portion 130 for reception by a female portion 120 of a fitting 110 of the personal care apparatus 10, the male portion 130 may include a side 160 having a corresponding portion for receiving a connection member 140 of the personal care apparatus 10, The attachment 40 may define a longitudinal axis A. The male portion 130 may comprise four male portion sides corresponding to a trapezoidal cross-section along the male portion 130 along substantially all of the longitudinal axis A. The trapezoidal cross-section may comprise a base side having a first length, two joining sides extending from the base side at an acute angle, and a top side (corresponding to side 160 as shown in FIG. 5) attached to the two joining sides at an obtuse angle. The top side may have a length less that the base side. The trapezoidal cross-section may have a cross-section conforming to an isosceles trapezium. The corresponding portion may comprise a recess for receiving a ball plunger 150 and/or a spring clip 152 (e.g., of a fitting 110 of the personal care apparatus). As shown in FIG. 5, the recess 170 may extend across a plane perpendicular to the longitudinal axis A across substantially all of the two sides and the top side. The recess 170 may extend across a plane perpendicular to the longitudinal axis A across substantially all of the two sides and the base side (not shown). The recess 170 may extend across a plane perpendicular to the longitudinal axis A across substantially all of the two sides, the base side, and the top side (not shown). Such configurations of the male portion 130 may allow for flexibility in the positioning of said spring clips and/or ball plunger(s) when the fitting is present. At least three of the four sides of the male portion 130 may be configured to abut a corresponding at least three internal sides of the female portion 120 of the fitting 110, in use, when the male portion 130 is in reception of the female portion 120 of the fitting 110. All of the four sides of the male portion 130 may be configured to abut a corresponding at least three internal sides of the female portion 120 of the fitting 110, in use, when the male portion 130 is in reception of the female portion 120 of the fitting 110. Such a configuration of the male portion 130 may provide for an improved interference fit of the male and female portions in use, additionally to the secured cooperation provided by the ball plunger 150 and/or spring clip 152 and the recess 170. The attachment 40 may be a removable toothbrush head. The toothbrush head may comprise a toothbrush arm extending along the longitudinal axis A. The toothbrush head may be attached to the male portion 130 and may comprise a bristle portion.

The personal care apparatus 10 may be a toothbrush.

The attachment 40 may be a removable toothbrush head.

According to a second aspect there is provided an attachment 40 for a personal care apparatus 10 as described herein. The attachment 40 may have one, or more, or all of the features and/or advantages of the attachment 40 as described above.

The attachment 40 may comprise a male portion 130 for reception by a female portion 120 of a fitting 110 of a personal care apparatus 10, the male portion 130 including a side 160 having a corresponding portion for receiving a connection member 140 of the personal care apparatus 10. The corresponding portion may be a recess 170. The side 160 may be flat. Attachments 40 having a flat side 160 provide advantages, in that, in contrast to e.g., a fully cylindrical male portion, the flat side 160 may secure against a corresponding flat side of the fitting 110 and prevent rotational movement of the attachment 40 within the fitting 110, allowing the oscillatory movement provided by the escapement mechanism 30 to be efficiently translated to the attachment 40. The recess 170 may allow for secure fitting 110 of the male portion 130 of the attachment 40 within the fitting 110, as described above. Further corresponding shapes between the female portion 120 and the male portion 130 may provide equivalent advantages as the flat male portion 130 as described above; for example, a male portion having a semi-circular, or trapezoidal, or dovetail cross section and a female portion having a corresponding shape may prevent rotational movement of the attachment 40 within the fitting 110 as described above.

The attachment 40 may define a longitudinal axis A. In particular, the attachment 40 may have a length which defines the longitudinal axis A, as shown by A in FIG. 5. The attachment may therefore have an elongate body attached to the male portion 130. The elongate body may have a trapezoidal cross-section along at least part of the longitudinal axis A extending along the elongate body.

The male portion 130 of the attachment 40 may comprise a trapezoidal cross-section and/or a dovetail cross section along at least part of the longitudinal axis A. As shown in FIG. 5, the male portion 130 may have a trapezoidal cross-section and/or a dovetail cross section along at least part, or all of, of the longitudinal axis A at a plane perpendicular to the axis. In other words, the male portion 130 may have a trapezoidal cross-section and/or a dovetail cross section along at least part of the longitudinal axis A along a length of the male portion extending along the longitudinal axis A. Therefore, the shape of the male portion may correspond to a trapezoidal prism and/or a dovetail prism along at least the length of the male portion. It will be appreciated that the shape of the male portion 130 may not be uniform along all of the length of the male portion 130 (i.e., where the recess is present, which may itself correspond to a trapezoid and/or dovetail (or another shape as described herein) cross-section of smaller cross-sectional area than the rest of the male portion 130). The trapezoidal cross-section may comprise an isosceles trapezium, a scalene trapezium, and/or a trapezium comprising a right angle between two of the sides of the trapezium. Male portions 130 having a trapezoidal cross-section and/or a dovetail cross section along at least part of, or all of, the longitudinal axis A at a plane perpendicular to the axis may provide advantages. In particular, that rotational movement of the male portion 130 when connected to the female portion 120 may be substantially prevented by virtue of the shape of the male portion 130 and the corresponding female portion 120. Further, such shapes (trapezoidal and/or dovetail) may allow for ease of manufacturing using eco-friendly materials such as bamboo. Furthermore, male portions having a cross-section that is not rotationally symmetrical (e.g., a trapezium and/or dovetail) may only enable the attachment/engagement of the male portion to 130 to/with the female portion 120 in a specific (single) orientation. The male portion may have a rotational symmetry of order 1. The rotational symmetry of order 1 may be about the longitudinal axis A.

Further, with reference to FIG. 8, it will be appreciated by the skilled person that alternative-shaped cross-sections may be used. FIG. 8 shows examples of the attachment 40 (represented as 40′, 40″, 40′″, 40″″, 40′″″, 40′″″″) having various shaped male portions 130 (represented as 130′, 130″, 130′″, 130″″, 130′″″, 130′″″″) with fittings 110 (represented as 110′, 110″, 110′″, 110″″, 110′″″, 110′″″″) having corresponding female portion 120 shapes (represented as 120′, 120″, 120′″, 120″″, 120′″″, 120′″″″) e.g., triangular, irregular trapezoidal (i.e., a trapezium without symmetry), semi-circular, square, crescent moon shaped, etc. With reference to FIG. 8, the male portion 130 of the attachment 40 may comprise an irregular, a circular, oval (represented by 130″″ in FIG. 8), triangular (represented by 130′″″ in FIG. 8), quadrilateral (e.g., rectangular as represented by 130″ in FIG. 8 or trapezoidal as represented by 130′ in FIG. 8)), pentagonal, hexagonal (represented by 130′″ in FIG. 8), heptagonal, and/or octagonal cross section, and/or any polygonal shaped cross-section, e.g., a cross-shaped cross-section (represented by 130′″″″ in FIG. 8), along at least part of (or all of) the length of the male portion. Further, the fitting 110 may therefore comprise a female portion 120 shaped and sized to receive the male portion 130 of the attachment 40 securely, e.g., shaped to correspond to the cross-sectional shape of the male portion 130, such that free movement of the male portion 130 when engaged within the female portion 120 of the fitting 110 is minimised. For example, as represented in FIG. 8, the female portion 120 may have a cross section that is: trapezoidal 120′, rectangular 120″, hexagonal 120′″, oval 120″″, triangular 120′″″, or cross-shaped 120′″″″. Further, the male portion may transition from a cross-section of a first shape (any of the shapes as described above) to a cross-section of a second shape (any of the other shapes as described above). At least one of the corners of the shape of the male portion 130 (i.e., where two sides or faces join at an edge) may be chamfered, rounded, and/or radiused. A male portion 130 having n number of faces (i.e., sides) may abut n or n−1 number of faces against a corresponding number of internal faces of the female portion 120, such that rotational movement of the male portion 130 when connected to the female portion 120 may be substantially prevented, increasing the friction fit of the male portion 130 and the female portion 120. The attachment 40 may be slidably connectable to the fitting 110 along the longitudinal axis A.

As shown in FIG. 5, the recess 170 may extend across the flat side 160 (which may be flat, as shown in FIG. 5) from a first edge to a second edge. When the recess 170 is provided in this way, the recess 170 may receive the connection member 140 readily. The recess 170 may extend around all of, or all but one, or all but two, or all but three sides of the male portion, in particular, if the male portion has n number of sides (e.g., a male portion with a square or trapezoidal cross-section has four), then the recess may extend around n, n−1, n−2, n−3 . . . n−(n−3), n−(n−2), n−(n−1) sides of the male portion 130 (i.e., the recess may extend around any number of sides up to and including n sides). The recess 170 may extend around substantially all of (an outer surface of) the male portion 130. Recesses 170 when configured as described above may further allow the male portion 130 to engage with the fitting 110, if, e.g., connection members comprising a spring clip 152 and a ball-plunger 150 (as described below) were used, or if two ball plungers were used to secure the attachment 40 to the fitting 110, and may allow for flexibility in the positioning of said spring clips and/or ball plunger(s). The spring clip 152 may fit in to the same recess as the ball plunger. The fitting may be removably or permanently fixed to the personal care device 10.

The attachment 40 may include the personal care apparatus 10 and the fitting 110, 1100. The personal care apparatus 10 may have one or more or all of the features and/or advantages of the personal care apparatus 10 as described herein (the personal care apparatus may therefore be spring powered). The fitting 110, 1100 may have one or more or all of the features and/or advantages of the fitting 110, 110 as described herein.

The fitting 110 may comprise a connection member 140 for engaging with a corresponding portion of the male portion 130. The fitting 110 may comprise the connection member 140 on an inner surface of the female portion 120 for engaging with a corresponding portion of the male portion 130. The fitting 110 may therefore readily receive an attachment 40 having a corresponding male portion 130. The fitting 110 may therefore secure the attachment 40 to the personal care device.

The connection member 140 may comprise a ball-plunger 150. As shown in FIG. 5, the connection member 140 may additionally or alternatively comprise a spring clip 152. The connection member 140 as described may therefore readily secure the attachment 40 to the fitting 110, and provide resistance against removal of the attachment 40 from the fitting 110. Further, the connection member 140 as described may provide tactile feedback (e.g., a click feeling and/or noise) to notify the user that the attachment 40 is secured in the fitting 110. Further, as shown in FIG. 5, the connection member 140, such as a spring clip 152, need not be on an inner surface of the female portion 120 and, in the case of the spring clip 152, may be provided around an outer portion of the fitting 110 to secure the male portion 130 of the attachment 40 within the fitting 110.

By way of example, a preferred embodiment of the attachment 40 is described with reference to FIG. 5. It will be appreciated by the skilled person that the preferred features of the attachment 40 as described below may be included with any of the features of the attachment 40 as described herein. The attachment 40 may comprise a male portion 130 for reception by a female portion 120 of a fitting 110 of the personal care apparatus 10, the male portion 130 may include a side 160 having a corresponding portion for receiving a connection member 140 of the personal care apparatus 10, The attachment 40 may define a longitudinal axis A. The male portion 130 may comprise four male portion sides corresponding to a trapezoidal cross-section along the male portion 130 along substantially all of the longitudinal axis A. The trapezoidal cross-section may comprise a base side having a first length, two joining sides extending from the base side at an acute angle, and a top side (corresponding to side 160 as shown in FIG. 5) attached to the two joining sides at an obtuse angle. The top side may have a length less that the base side. The trapezoidal cross-section may have a cross-section conforming to an isosceles trapezium. The corresponding portion may comprise a recess for receiving a ball plunger 150 and/or a spring clip 152 (e.g., of a fitting 110 of the personal care apparatus). As shown in FIG. 5, the recess 170 may extend across a plane perpendicular to the longitudinal axis across substantially all of the two sides and the top side. The recess 170 may extend across a plane perpendicular to the longitudinal axis across substantially all of the two sides and the base side (not shown). The recess 170 may extend across a plane perpendicular to the longitudinal axis across substantially all of the two sides, the base side, and the top side (not shown). Such configurations of the male portion 130 may allow for flexibility in the positioning of said spring clips and/or ball plunger(s) when the fitting is present. At least three of the four sides of the male portion 130 may be configured to abut a corresponding at least three internal sides of the female portion 120 of the fitting 110, in use, when the male portion 130 is in reception of the female portion 120 of the fitting 110. All of the four sides of the male portion 130 may be configured to abut a corresponding at least three internal sides of the female portion 120 of the fitting 110, in use, when the male portion 130 is in reception of the female portion 120 of the fitting 110. Such a configuration of the male portion 130 may provide for an improved interference fit of the male and female portions in use, additionally to the secured cooperation provided by the ball plunger 150 and/or spring clip 152 and the recess 170. The attachment 40 may be a removable toothbrush head. The toothbrush head may comprise a toothbrush arm extending along the longitudinal axis. The toothbrush head may be attached to the male portion 130 and may comprise a bristle portion.

The attachment 40 may be a removable toothbrush head.

The personal care apparatus 10 may be a toothbrush.

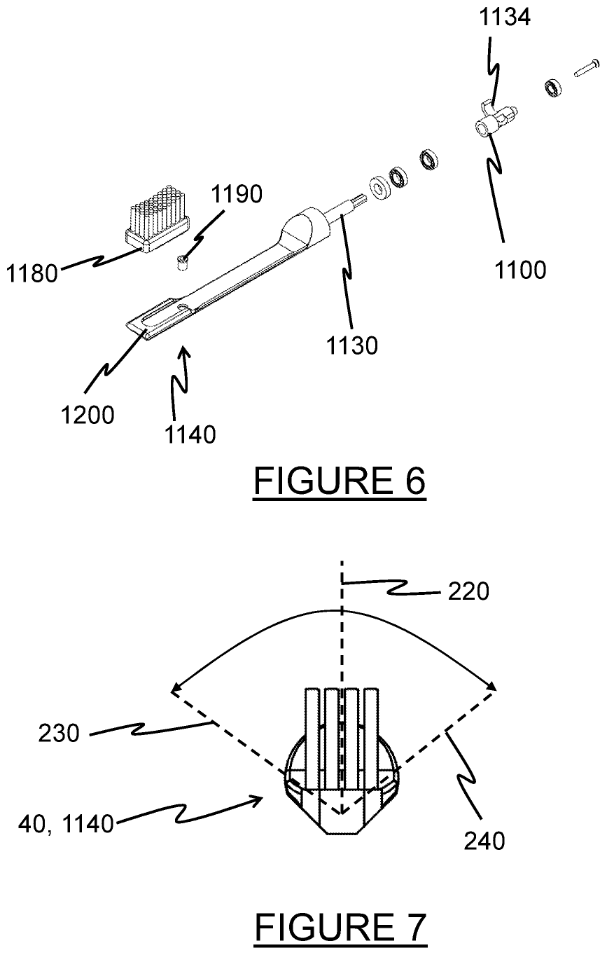

There is also provided an alternative attachment 1140 in the form of a toothbrush head as described herein, as shown by FIG. 6, with a cylindrical male portion 1130, and a fitting 1100 as described herein directly attached to the rocker arm 1134 of the escapement mechanism. It will be appreciated by the skilled person that the toothbrush head with a removable bristle portion 1180 may include any of the features of the attachment 40 as described herein, such as the male portion 130 and the possible cross-sectional shapes of the male portion 130 as described herein. Further, it will be appreciated by the skilled person that the fitting 1100 may include any of the features of the fitting 110 as described herein. Further, as shown by FIG. 6, the removable toothbrush head may include a removable bristle portion 1180 comprising a side having a recess for receiving a head connection member 1190. The side may be flat. Therefore, the removable bristle portion 1180 itself may be replaced without replacing the entire toothbrush head, reducing environmental waste. The removable toothbrush head may include a toothbrush head arm comprising the head connection member 1190. Accordingly, the toothbrush head arm and bristle portion 1180 may be securely attached to one-another.

The removable bristle portion 1180 may be slidable along the arm along the longitudinal axis into a receiving portion 1200 of the toothbrush head arm, such that the head connection member 1190 may engage with the recess and the removable bristle portion 1180 may be retained on the toothbrush head arm. The receiving portion 1200 as shown in FIG. 6 is shown as a lipped portion for retaining the removable bristle portion 1180 within. When attached in this way, the oscillatory movement of the attachment of the head may not loosen the connection of the removable bristle portion 1180 from the toothbrush head arm.

The head connection member 1190 of the toothbrush head arm may comprise a ball-plunger, as shown in FIG. 6. The head connection member 1190 may additionally or alternatively comprise a spring clip (not shown). The head connection member 1190 as described may therefore readily secure the bristle portion to the toothbrush head arm and provide resistance against removal of the attachment from the receiving portion. Further, the head connection member 1190 as described may provide tactile feedback (e.g., a click feeling and/or noise) to notify the user that the bristle portion 1180 is secured in the receiving portion of the toothbrush head arm.

The attachment 40, 1140 as described herein and/or the toothbrush head and/or the toothbrush head arm and/or the bristle portion may be made of a recyclable material, such as bamboo, and/or woody material, and/or recyclable plastic. The housing 12, and/or the winding arm 70, and/or the fitting of the personal care device may be made of a recyclable material, such as bamboo, and/or woody material, and/or recyclable plastic, and/or recyclable metal such as aluminium. Such recyclable materials are environmentally friendly and when, e.g., an attachment is disposed of, there may be minimal environmental impact, e.g., bamboo is biodegradable and compostable. Further, bamboo may provide anti-bacterial and anti-fungal properties and may be lightweight compared to known materials, e.g., plastic and/or metal.

The attachment may be an adapter. When the attachment is an adapter, the attachment may be used to attach a further attachment to the fitting of the personal care apparatus 10. The further attachment as described above may have one, or more, or all of the features of the attachment as described above. In particular, the attachment may comprise a female portion 120 configured to receive a male portion of a further attachment. The further attachment may be a toothbrush head. The attachment may comprise a connection member for securing against a male portion of the further attachment, in the same manner as the connection member of the fitting when used for securing an attachment as described above.

Alternatively, the attachment may comprise a male portion configured to be received into a female portion of a further attachment. In other words, the attachment may act as an adapter for connecting a further attachment, e.g., a known toothbrush head, to the fitting of the personal care apparatus 10. The attachment may comprise a securing member for securing against a male or female portion of the further attachment. The securing member may comprise a ball plunger and/or a spring clip.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A personal care apparatus, including:
a housing,
a winding mechanism located at a first end of the housing,
an escapement mechanism located at a second end of the housing configured to oscillate an attachment, and
a plurality of spiral springs connected in series within the housing, the springs connected to the winding mechanism and the escapement mechanism.

2. The personal care apparatus according to claim 1, wherein the escapement mechanism is a runaway escapement.

3. The personal care apparatus according to claim 1, wherein the winding mechanism comprises:
a winding shaft extending through the first end of the housing and connected to the plurality of spiral springs; and
a winding member connected to the winding shaft and configured to impart rotational force on the winding shaft.

4. The personal care apparatus according to claim 3, wherein the winding member comprises a winding arm that is pivotably rotatable about the housing to fit into a recess in the housing, such that the winding arm is stowed when not in use.

5. The personal care apparatus according to claim 1, wherein the plurality of spiral springs comprises:
a first spiral spring housed within and connected to a first barrel located within the housing adjacent the first end, the first barrel connected to the winding mechanism, and
a terminal spiral spring housed within and connected to a terminal barrel located within the housing adjacent to the second end, the terminal spiral spring connected to the escapement mechanism.

6. The personal care apparatus according to claim 5, further including at least one or more further spiral spring(s) housed in and connected to a respective barrel located within the housing between the first and terminal spiral springs.

7. The personal care apparatus according to claim 1, further including a planetary gearbox connected to the escapement mechanism and the plurality of spiral springs.

8. The personal care apparatus according to claim 1, further including a stopping unit for preventing movement of the escapement mechanism.

9. The personal care apparatus according to claim 1, comprising a fitting connected to the escapement mechanism for receiving the attachment, and wherein the fitting comprises a female portion for reception of a male portion of the attachment.

10. The personal care apparatus according to claim 9, comprising a connection member on an inner surface of the female portion of the fitting for engaging with a corresponding portion of the male portion.

11. The personal care apparatus according to claim 10, wherein the connection member comprises a ball-plunger and/or a spring clip.

12. The personal care apparatus according to claim 9, including the fitting for the attachment and the attachment and wherein the attachment comprises a male portion for reception by the female portion of the personal care apparatus. the male portion including a side having a corresponding portion for receiving the connection member of the personal care apparatus, wherein the attachment defines a longitudinal axis, wherein the corresponding portion is a recess, and wherein the male portion has an irregular or polygonal cross-section along the male portion along at least part or all of the longitudinal axis.

13. (canceled)

14. The personal care apparatus according to claim 12, wherein the side of the male portion is flat, and/or the male portion of the attachment comprises a trapezoidal cross-section and/or a dovetail cross section along the male portion along at least part or all of the longitudinal axis, and optionally wherein the male portion has cross-sectional order of symmetry of 1.

15. The personal care apparatus according to claim 12, wherein the recess extends across the side from a first edge to a second edge, and/or wherein the recess extends around at least two-thirds of the outside of the male portion along a plane perpendicular to the longitudinal axis.

16. The personal care apparatus according to claim 1, wherein the personal care apparatus is a toothbrush and wherein the attachment is a removable toothbrush head.

17. (canceled)

18. An attachment for a personal care apparatus according to claim 1, wherein the attachment comprises a male portion for reception by a female portion of a fitting of the personal care apparatus, the male portion including a side having a corresponding portion for receiving a connection member of the personal care apparatus, wherein the attachment defines a longitudinal axis, wherein the male portion has an irregular or polygonal cross-section along at least part or all of the longitudinal axis, and wherein:
the male portion comprises four male portion sides corresponding to a trapezoidal cross-section along all of the male portion along the longitudinal axis and wherein the trapezoidal cross-section comprises a base side having a first length, two joining sides extending from the base side at an acute angle, and a top side attached to the two joining sides at an obtuse angle, the top side having a length less than the base side, the trapezoidal cross-section having a cross-section conforming to an isosceles trapezium;
the corresponding portion comprises a recess for receiving a ball plunger and/or a spring clip, the recess extending across a plane perpendicular to the longitudinal axis across:
substantially all of the two sides and the top side; or
substantially all of the two sides and the base side,
at least three of the four sides of the male portion are configured to abut a corresponding at least three internal sides of the female portion of the fitting, in use, when the male portion is in reception of the female portion of the fitting, and
the attachment is a toothbrush head comprising a toothbrush arm extending along the longitudinal axis, the toothbrush head attached to the male portion and comprising a bristle portion.

19. An attachment for a personal care apparatus according to claim 1, wherein the attachment comprises a male portion for reception by a female portion of a fitting of the personal care apparatus, the male portion including a side having a corresponding portion for receiving a connection member of the personal care apparatus, wherein the attachment defines a longitudinal axis, wherein the corresponding portion is a recess, and wherein the male portion has an irregular or polygonal cross-section along the male portion along at least part or all of the longitudinal axis.

20. The attachment according to claim 19, wherein the side of the male portion is flat, and/or the male portion of the attachment comprises a trapezoidal cross-section and/or a dovetail cross section along the male portion along at least part or all of the longitudinal axis, and optionally wherein the male portion has cross-sectional order of symmetry of 1.

21. The attachment according to claim 19, wherein the recess extends across the side from a first edge to a second edge and/or wherein the recess extends at least two-thirds of the way around an outer surface of the male portion along a plane perpendicular to the longitudinal axis.

22. (canceled)

23. (canceled)

24. The attachment according to claim 18, wherein the attachment is a removable toothbrush head.

25. (canceled)

26. (canceled)
